(19) United States
(12) Patent Application Publication
(10) Pub. No.: US 2021/0215264 A1
(43) Pub. Date: Jul. 15, 2021

(54) HEMISPHERICAL POPPET CHECK VALVE

(71) Applicant: DAYCO IP HOLDINGS, LLC, Troy, MI (US)

(72) Inventors: David E. Fletcher, Davison, MI (US); David Snow, Redford, MI (US); Mitchell Emond, Shelby Township, MI (US); Matthew C. Gilmer, South Lyon, MI (US); Joseph Dennis, Farmington Hills, MI (US)

(73) Assignee: DAYCO IP HOLDINGS, LLC, Troy, MI (US)

(21) Appl. No.: 16/739,296

(22) Filed: Jan. 10, 2020

(51) Int. Cl. F16K 27/02; F16K 15/06

(52) U.S. Cl. CPC F16K 27/0209; F16K 15/063

(57) ABSTRACT

Check valves have a housing defining an internal cavity and a first port and a second port both in fluid communication with the internal cavity and have a hemispherical poppet sealing member within the internal cavity and translatable between a closed position against an annular seat within the internal cavity of the housing and an open position. The annular seat, in a longitudinal cross-section through the check valve, defines a convex spherical radius and, in the closed position, a convex surface of the hemispherical poppet sealing member is sealing engaged with the convex spherical radius of the annular seat.

### TECHNICAL FIELD

This application relates to check valves for use in engine systems such as internal combustion engines, more particularly, to check valves having a hemispherical poppet sealing member.

### BACKGROUND

Engines, for example vehicle engines, have many uses for check valves, especially check valves that allow flow in one direction only. In engines that have multiple systems operating on vacuum or fluid assist, conditions exist that may make it difficult for a check valve to seal effectively. This is undesirable, and new check valves are needed to provide more efficient sealing with reduced flow restriction when open.

### SUMMARY

In all aspects, check valves are disclosed that have a housing that defines an internal cavity and a first port and a second port. The first port and the second port are both in fluid communication with the internal cavity. A hemispherical poppet sealing member is seated within the internal cavity and is translatable between a closed position against an annular seat of the housing and an open position. The annular seat, in a longitudinal cross-section through the check valve, defines a convex spherical radius and, in the closed position, a convex surface of the hemispherical poppet sealing member is sealing engaged with the convex spherical radius of the annular seat. The annular seat is typically formed at a transition from the first port into the internal cavity and the internal cavity has a generally spherical shape.

In all aspects, one or both of the annular seat and the hemispherical poppet sealing member may include a ring of elastomeric sealing material to define the convex spherical radius of the annular seat or the portion of the convex surface of the hemispherical poppet sealing member that engages the annular seat in the closed position. When the ring of elastomeric sealing material is present it can be insert molded or co-molded as part of one or both of the annular seat and the hemispherical poppet sealing member.

In all aspects, the housing is a multi-piece housing having a first housing portion defining the first port and a second housing portion defining the second port. The first housing portion terminates away from the first port with a double flanged end. An interior flange of the double flange is shorter than an exterior flange of the double flange and the interior flange is contoured to lie radially inward of a rim of the second housing portion to collectively define the generally spherical shape of the internal cavity. In all embodiments, the first housing portion and the second housing portion can be spin-welded together. In one embodiment, the exterior flange of the first housing portion and the rim of the second housing portion have a snap-fit connection.

In all aspects, the housing includes a pin protruding into the internal cavity, the hemispherical poppet sealing member includes a hollow stem, and the pin of the housing is received in the hollow stem of the sealing member for translation of the hemispherical poppet sealing member along the pin. The hemispherical poppet sealing member has a cupped underside defining an outer rim, and the outer rim has an elastomeric flange extending radially outward that, in the closed positioned, forms a clearance fit or an interference fit with a surface of the internal cavity. The elastomeric flange has a hinged feature for bending the elastomeric flange away from the surface of the internal cavity in the open position.

In all aspects, a spring can be seated in the internal cavity in a biasing orientation against the cupped underside of the hemispherical poppet sealing member, but is not required for all embodiments. In one embodiment, the hemispherical poppet sealing member is normally closed. In another embodiment, the hemispherical poppet sealing member is normally neutral.

In another aspect, engine systems are disclosed that include the check valves disclosed herein.

### BRIEF DESCRIPTION OF THE DRAWINGS

FIG. 1 is a front perspective view of a check valve.

FIG. 2 is a longitudinal, cross-sectional view of one embodiment of the check in the closed position.

FIG. 3 is a longitudinal, cross-sectional view of the check valve of FIG. 2 in the open position.

FIG. 4 is an enlarged view of the seal in the circle A of FIG. 2.

FIG. 5 is longitudinal, cross-sectional view of the check valve chamber of a second embodiment of a check valve.

FIG. 6 is longitudinal, cross-sectional view of the check valve chamber of a third embodiment of a check valve.

### DETAILED DESCRIPTION

The following detailed description will illustrate the general principles of the invention, examples of which are additionally illustrated in the accompanying drawings. In the drawings, like reference numbers indicate identical or functionally similar elements.

As used herein, “fluid” means any liquid, suspension, colloid, gas, plasma, or combinations thereof.

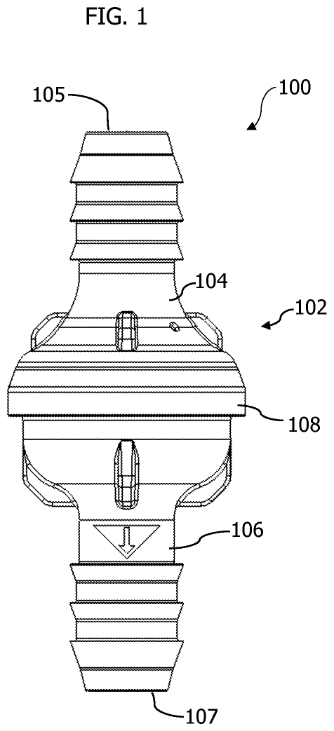

FIGS. 1-4 disclose a check valve 100 that includes a housing 102 having a first housing portion 104 defining a first port 105 and a second housing portion 106 defining a second port 107 that are sealingly fixed together with a fluid-tight seal at flange 108 and collectively define an internal cavity 110. The first port 105 and the second port 107 are both in fluid communication with the internal cavity 110. The internal cavity 110 typically has larger dimensions than the first port 105 and the second port 107. In the illustrated embodiment, the first port 105 and the second port 107 are positioned opposite one another to define a generally linear flow path through the check valve 100, when the hemispherical poppet sealing member 114 is not present, but is not limited to this configuration. In another embodiment, the first and second ports may be positioned relative to one another at an angle of less than 180 degrees.

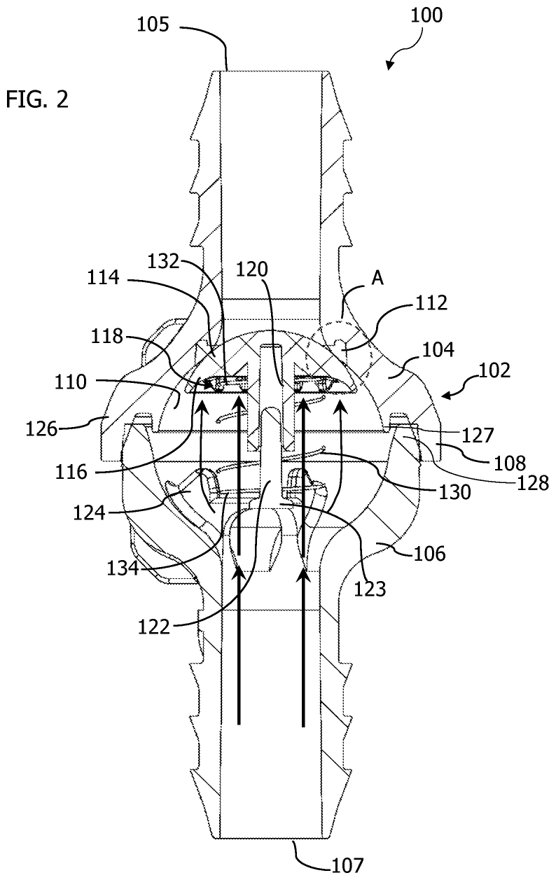

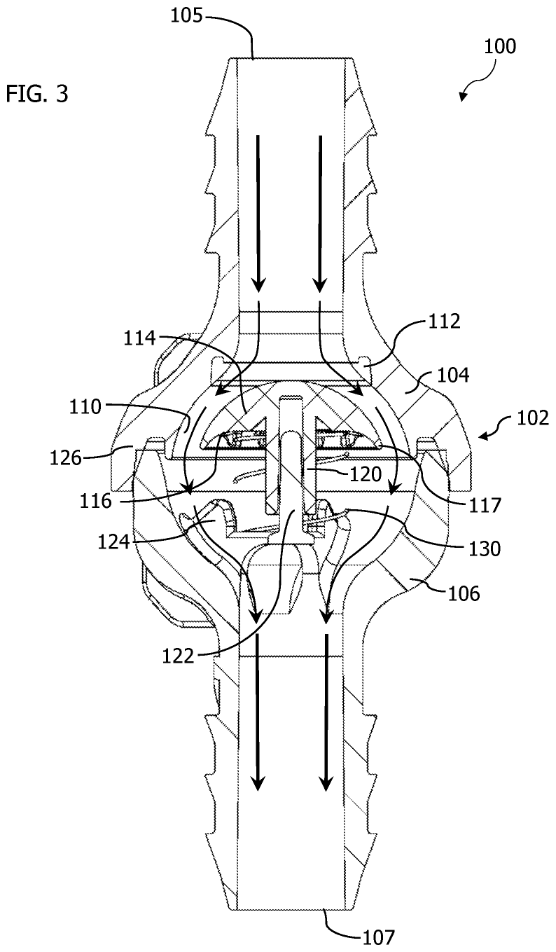

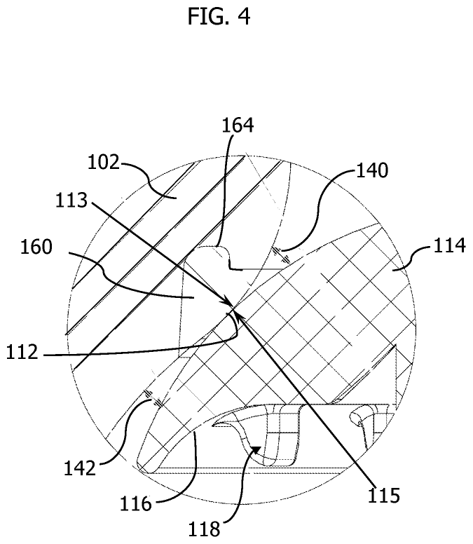

The internal cavity 110 is generally spherically shaped and defines an annular seat 112 for engagement with a hemispherical poppet sealing member 114, which is translatable between a closed position against the annular seat 112 (FIG. 2) and an open position (FIG. 3). The generally spherical shape of the internal cavity 110 complements the shape of the hemispherical poppet sealing member 114 and provides a low restriction flow path in the open position. The annular seat 112 in a longitudinal cross-section through the check valve 100, as shown in FIGS. 2 and 3, defines a convex spherical radius as indicated by arrow 113 in FIG. 4. The convex spherical radius of the annular seat is preferably positioned or formed at a transition from the first port 105 into the internal cavity 110. The internal cavity 110 has a generally spherical shape and, in the closed position, a convex surface of the hemispherical poppet sealing member 114 as indicated by arrow 115 in FIG. 4 is engaged with the convex spherical radius 113 of the annular seat 112.

Referring to FIG. 4, the convex surface-convex surface seal is shown as an enlarged image. This seal forms a tangent seal interface that is insensitive to slight misalignment of the hemispherical poppet sealing member 114 when closing. A slightly misaligned hemispherical poppet sealing member will still have good seal integrity, approximately 0.5 scc/m or less. As seen, the interior of the housing 102 has, in a longitudinal cross-section, a partial “S” shaped curve centered about the convex spherical radius 113, which defines gaps 140, 142 between the hemispherical poppet sealing member and the housing above and below the convex surface-convex surface seal, based on the orientation of the figure to the page.

Turning back to FIGS. 2 and 3, to aid in seal alignment, the internal cavity 110 has a pin 122 centrally positioned and protruding into the cavity opposite the annual seat 112. The hemispherical poppet valve 114 has a cupped underside 116 defining a first seat 118 for an optional spring 130 and has a hollow stem 120 protruding from the cupped underside 116 toward the pin 122 and receives the pin 122 therein for translation of the hemispherical poppet sealing member 114 along the pin 122. When spring 130 is present, a first end 132 of the spring 130 is seated and retained by first seat 118 in the cupped underside 116 of the hemispherical poppet sealing member 114 and a second end 134 of the spring 130 is seated and retained be a second seat 124 defined by the housing 102 and protruding into the internal cavity proximate a base 123 of the pin 122. The cupped underside 116 of the hemispherical poppet sealing member 114 provides a large restriction to fluid flow in the “non-flow direction” represented by the arrows in FIG. 2, thereby producing sufficient force to translate the sealing member to the closed position, even without the spring force provided by the spring, if desired.

Because of the overall shape of the hemispherical poppet sealing member described above, the check valves disclosed herein can have a “normally closed” configuration or a “normally neutral” configuration. A “normally closed” check valve is in the closed position until the pressure differential (change in pressure) between the inlet and the outlet is sufficient to overcome the spring holding the poppet in the closed position. A “normally neutral” check valve is neither open nor closed and depends on sufficient pressure differential to overcome the minimal mass of the poppet to be in either the open or closed position, depending on the flow direction. The normally neutral check valve can include spring 130 or may be devoid of a spring and translate the sealing member solely based on the pressure differentials experienced during operation of an engine system in which the check valve 100 is included. When used as a “normally closed” check valve the opening pressure differential can be tuned by varying the spring rate and preselected spring force at installation of the spring.

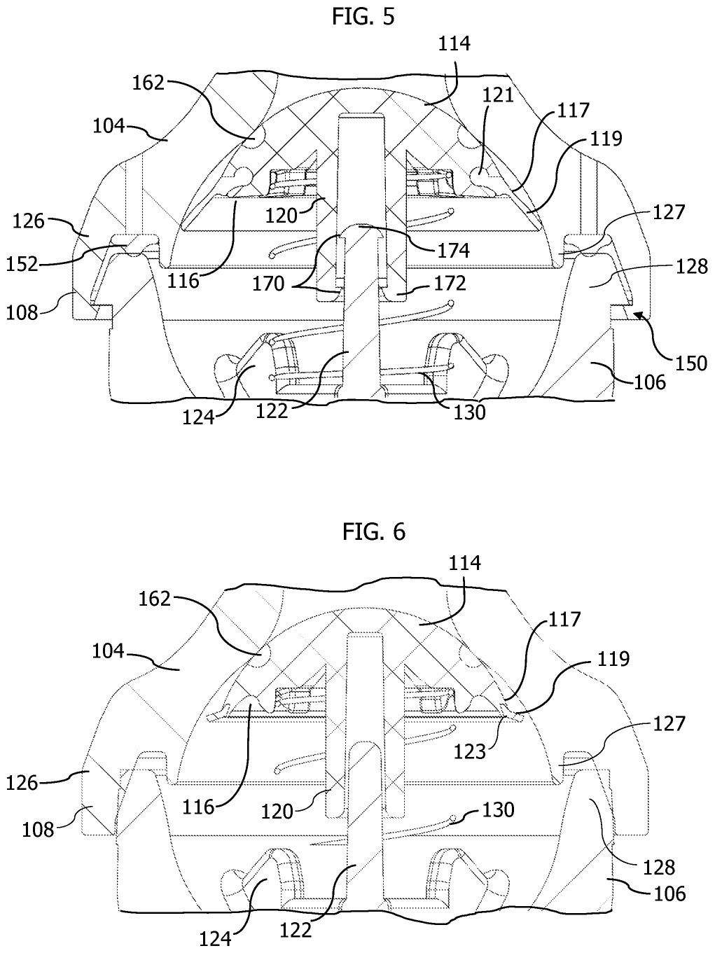

Referring to FIG. 2-6, in all embodiments, one or both of the annular seat 112 and the hemispherical poppet sealing member 114 include a ring of elastomeric sealing material 160 (FIGS. 2-4) to define the convex spherical radius 113 of the annular seat 112 or to define the portion of the convex surface 162 of the hemispherical poppet sealing member 114 (FIGS. 5 and 6) that engages the annular seat 112 in the closed position. The ring of elastomeric sealing material 160 matches (is flush with) the partial “S” shaped curved contour of the first housing portion 104 so as not to create a flow restriction, in the open position and the ring of elastomeric sealing material 162 matches (is flush with) the hemispherical surface of the hemispherical poppet sealing member 114 so as not to create a flow restriction, in the open position. The ring of elastomeric sealing material 160, 162 is insert molded or co-molded as part of one or both of the annular seat 112, i.e., first housing portion 104, and the hemispherical poppet sealing member 114. Either or both of the rings of elastomeric sealing material 160, 162 may include an annular lip 164 best seen in FIG. 4 to help retain the molded elastomeric sealing material 160, 162 in place in its respective member.

The ring of elastomeric sealing material 160, 162 may be formed of a fluoroelastomer. Suitable fluoroelastomers include, but are not limited to, polyvinyl fluoride, polyvinylidene fluorides, polytrifluoromonochloroethylene, polytetrafluoroethylene, polyhexafluoropropylene, polydifluoroethylene, polytetrafluoroethylene, fluorosilicone, ethylene-tetrafluoroethylene copolymer, hexafluoropropylene-tetrafluoroethylene copolymer, hexafluoropropylene-difluoroethylene copolymer, perfluoroalkoxytetrafluoroethylene copolymer, tetrafluoroethylene-hexafluoropropylene-vinylidene fluoride terpolymer, or other commercially available elastomeric material that will provide seal integrity at both low pressure differentials (such as 5 kPa) and at high pressure differentials (such as 200 kPa), and blends thereof. Ethylene propylene diene monomer and derivatives thereof are also suitable for the ring of elastomeric sealing material 160, 162.

In all embodiments, the hemispherical poppet sealing member 114 has a cupped underside 116 defining an outer rim 117. The poppet can be made of polyoxymethylene, polyamides, polypropylene, polyphenylene ether or polyphenylene oxide, or other commercially available polymers that would meet the temperature and strength requirements of the application.

Referring now to FIGS. 5 and 6, the outer rim 117 can include an elastomeric flange 119 extending radially outward that, in the closed positioned, forms a clearance fit or an interference fit with a surface of the internal cavity 110. This elastomeric flange 119 enhances the ability of the hemispherical poppet sealing member 114 to close under low reverse flow conditions. The elastomeric flange 119 is insert molded or co-molded to the hemispherical poppet sealing member 114 and may include a head 121 inserted into the hemispherical poppet sealing member 114 as shown in FIG. 5. The elastomeric flange 119 as shown in FIG. 6 may include a hinge feature 123 that allows the elastomeric flange 119 to bend out of the way in response to the pressure differentials in the system to maintain minimal restrictions on the fluid flow through the check valve in the open position, i.e., the flange 119 bends away from the surface of the internal cavity 110 toward the stem 120 and the pin 122.

With reference to all the figures, the first housing portion 104 terminates away from the first port 105 with a double flanged end 126, wherein an interior flange 127 of the double flange is shorter than an exterior flange 108 of the double flange and the interior flange 127 is contoured to lie radially inward of a rim 128 of the second housing portion 106 to collectively define the generally spherical shape of the internal cavity 110. The spherical radius and/or the radial position of spherical radius center of the first housing portion's profile is slightly less than the spherical radius and/or the radial position of spherical radius center of the second housing portion's profile, which creates an “overlap” of the interior flange 127 with the rim 128 described above and provides a low restriction flow path as well as low audible noise in the check valves 100.

The exterior flange 108 of the first housing portion 104 and the rim 128 of the second housing portion 106 can have a snap-fit connection 150 as shown in FIG. 5. In all embodiments, the first housing portion 104 and the second housing portion 106 can be formed of a plastic material suitable for combustion engine environments and can be spin-welded together. As shown in FIG. 5, the double flange end 126 of the first housing portion 104 can include an annular bead of sealing material 152 between the interior flange 127 and the exterior flange 108 to provide additional material for the spin weld.

Referring again to FIG. 5, the open end 172 of the stem 120 and the head 174 of the pin 122 can have snap-fit features 170 to assist in maintaining the position of the hemispherical poppet sealing member 114 during assembly of the check valve 100.

In all aspects, the housing is typically molded of plastic, such as, but not limited to, nylon 6, nylon 4/6, nylon 6/6, polyoxymethylene, and/or other commercially available plastics that will provide fluid tight seal integrity at both low pressure differentials (such as 5 kPa) and at high pressure differentials (such as 200 kPa) and are suitable for engine operating systems that can experience pressures between 101 kPa to −80 kPa and temperatures between −40° C. to 20° C., as well as road and weather conditions and debris.

The check valves disclosed herein have several advantages over other check valves. One advantage is that the check valves open under low differential pressure, such as but not limited to a difference of 5 kPA and has low flow restriction once open. The low flow restriction in the open position is a result of the combined shapes of the generally spherical internal cavity and the upper surface of the hemispherical poppet sealing member (see the flow arrows in FIG. 3), more particularly, the internal flange of the first housing portion overlapping the rim of the second housing portion and defining matching contours once sealingly fixed together. This configuration also provides low audible noise when open and a no-leak seal when closed.

Another advantage is that the check valves are not sensitive to how they are oriented in an engine system because the hemispherical poppet sealing member has a low mass. The mass is low enough that the hemispherical poppet sealing member is not moved to the closed position or to the open position simply by its own mass. Other advantages include a reduction in the leak rate when the sealing member is in a closed position, the option to be “normally closed” or “normally neutral”, easy to assemble, and lower manufacturing costs. A “normally closed” check valve is in the closed position until the pressure differential (change in pressure) between the inlet and the outlet is sufficient to overcome the spring holding the poppet in the closed position. A “normally neutral” check valve is neither open nor closed and depends on sufficient pressure differential to overcome the minimal mass of the poppet to be in either the open or closed position, depending on the flow direction. When used as a “normally closed” check valve the opening pressure differential can be tuned by varying the spring rate and install force of the spring.

Although the invention is shown and described with respect to certain embodiments, modifications will occur to those skilled in the art upon reading and understanding the specification, and the present invention includes all such modifications.

What is claimed is:

1. A check valve comprising:
a housing defining an internal cavity having a first port and a second port both in fluid communication therewith; and
a hemispherical poppet sealing member within the internal cavity and translatable between a closed position against an annular seat within the internal cavity of the housing and an open position;
wherein the annular seat in a longitudinal cross-section through the check valve defines a convex spherical radius, and in the closed position a convex surface of the hemispherical poppet sealing member is sealing engaged with the convex spherical radius of the annular seat.

2. The check valve of claim 1, wherein one or both of the annular seat and the hemispherical poppet sealing member include a ring of elastomeric sealing material to define the convex spherical radius of the annular seat or the portion of the convex surface of the hemispherical poppet sealing member that engages the annular seat in the closed position.

3. The check valve of claim 1, wherein the ring of elastomeric sealing material is insert molded or co-molded as part of one or both of the annular seat and the hemispherical poppet sealing member.

4. The check valve of claim 1, wherein the annular seat is formed at a transition from the first port into the internal cavity.

5. The check valve of claim 4, wherein the internal cavity has a generally spherical shape.

6. The check valve of claim 5, wherein a first housing portion defines the first port and a second housing portion defines the second port, and the first housing portion terminates away from the first port with a double flanged end, wherein an interior flange of the double flange is shorter than an exterior flange of the double flange and the interior flange is contoured to lie radially inward of a rim of the second housing portion to collectively define the generally spherical shape of the internal cavity.

7. The check valve of claim 6, wherein the exterior flange of the first housing portion and the rim of the second housing portion have a snap-fit connection.

8. The check valve of claim 7, wherein the first housing portion and the second housing portion are spin-welded together.

9. The check valve of claim 1, wherein the housing includes a pin, the hemispherical poppet sealing member includes a hollow stem, and the pin of the housing is received in the hollow stem of the sealing member for translation of the hemispherical poppet sealing member along the pin.

10. The check valve of claim 1, wherein the hemispherical poppet sealing member has a cupped underside defining an outer rim, and wherein the outer rim comprises an elastomeric flange extending radially outward that, in the closed positioned, forms a clearance fit or an interference fit with a surface of the internal cavity.

11. The check valve of claim 10, wherein the elastomeric flange has a hinged feature for bending the elastomeric flange away from the surface of the internal cavity in the open position.

12. The check valve of claim 1, wherein a spring is seated in the internal cavity in a biasing orientation against the cupped underside of the hemispherical poppet sealing member.

13. The check valve of claim 12, wherein the hemispherical poppet sealing member is normally closed.

14. The check valve of claim 12, wherein the hemispherical poppet sealing member is normally neutral.

15. An engine system comprising:
a check valve according to claim 1 controlling fluid flow through a conduit therein.

16. The engine system of claim 15, wherein one or both of the annular seat and the hemispherical poppet sealing member include a ring of elastomeric sealing material to define the convex spherical radius of the annular seat or the portion of the convex surface of the hemispherical poppet sealing member that engages the annular seat in the closed position.

17. The engine system of claim 15, wherein the ring of elastomeric sealing material is insert molded or co-molded as part of one or both of the annular seat and the hemispherical poppet sealing member.

18. The engine system of claim 16, wherein the internal cavity has a generally spherical shape.

19. The check valve of claim 1, wherein the housing includes a pin, the hemispherical poppet sealing member includes a hollow stem, and the pin of the housing is received in the hollow stem of the sealing member for translation of the hemispherical poppet sealing member along the pin.

20. The check valve of claim 1, wherein the hemispherical poppet sealing member has a cupped underside defining an outer rim, and wherein the outer rim comprises an elastomeric flange extending radially outward that, in the closed positioned, forms a clearance fit or an interference fit with a surface of the internal cavity.
